(19) United States
(12) Patent Application Publication
(10) Pub. No.: US 2008/0007887 A1
(43) Pub. Date: Jan. 10, 2008

(54) Electrodes, devices, and methods for electro-incapacitation

(75) Inventor: James C. Weaver, Sudbury, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: MASSACHUSETTS INSTITUTE OF TECHNOLOGY, Cambridge, MA (US)

(21) Appl. No.: 11/811,758

(22) Filed: Jun. 11, 2007

Related U.S. Application Data
(60) Provisional application No. 60/812,640, filed on Jun. 9, 2006.

(51) Int. Cl. F41B 15/04; H01S 4/00

(52) U.S. Cl. 361/232; 29/592.1

(57) ABSTRACT

Electrodes, methods, and devices are provided for incapacitating or immobilizing a target. More particularly, the electrodes, methods, and devices disclosed provide for a reduced spacing between equipotentials near an electrode and reduced localized cellular damage created by an electrical exposure from an electrode. In one exemplary embodiment, an electrode is configured to be approximately flat, which in turn, at least, creates a greater surface area and thus reduces spacing between equipotentials. In another exemplary embodiment, an electrode is configured to include a curvature, which in turn, at least, allows the electrode to intent or dimple the skin less than in current conventional designs. Devices incorporating these electrodes are also provided, as are various techniques both for manufacturing such devices and for incapacitating a target.

### PRIORITY OF THE INVENTION

The present invention claims priority to U.S. Provisional Application No. 60/812,640, “Electrodes and Process for Human Electro-Incapacitation.” and filed on Jun. 9, 2006.

### FIELD OF THE INVENTION

The present invention generally relates to equipotential exposures created by electro-incapacitation devices, and more specifically relates to electrodes, devices, and methods for reducing both spacing between equipotentials near an electrode and localized cellular damage created by equipotential exposures from electro-incapacitation devices.

### BACKGROUND OF THE INVENTION

The use of electronic devices in order to control, stun, and/or incapacitate a target have been known and used in the United States for well over a century, dating at least back to May 13, 1890 when U.S. Pat. No. 427,549, entitled “Electric Prod Pole,” issued to John M. Burton. Since Mr. Burton's electric prod pole, a myriad of electronic devices have been created to control, stun, and/or incapacitate a target. Today these electronic devices are used in many capacities, including commonly in the areas of personal security, law enforcement, and military operations. Electronic devices used in these areas are known by a variety of names, including: electro-incapacitation devices, electromuscular incapacitation devices, neuromuscular incapacitation devices, human electromuscular incapacitation devices, conducted electrical weapons, stun guns, and TASER®s. Other variations of the device names include substituting forms of the words disable and incapacitate for incapacitation, and interchangeably using the words device, weapon, gun, and tool. Furthermore, these devices, hereinafter generally referred to as electro-incapacitation devices, come in a variety of different forms, including: prods, batons, nightsticks, projectile style guns, and non-projectile style guns.

While electro-incapacitation devices have been in existence for a long period of time, there is still a growing concern related to the safety of these devices as currently designed. While perhaps the most publicized concern relates to the effect these devices have on cardiac function, there are other side effects that also result from the use of these devices. For instance, the electric shock can cause damage to the nervous system by damaging the myelinated fibers, disintegrating the myelin sheath, and swelling the nerve tissue. The devices as currently designed have also been reported to cause contusions, abrasions, lacerations, lesions, cutaneous current marks, tissue damage, mild rhabdomyolysis, blisters, carbonization of the skin, second degree burns, and testicular torsion, among other side effects. Further, there have even been some studies linking electro-incapacitation devices as currently designed and used to potentially causing ventricular fibrillation or even death. However, little is actually known about all of the various side effects associated with electro-incapacitation devices because there are few published observations of such effects. More studies are needed to determine injury thresholds, the effect on the nervous systems, and micromophological or histological changes of the skin following injuries resulting from the use of the devices.

Electro-incapacitation devices generally operate by providing a high peak voltage and a low average current stimulator to generate an electrical stimulus. The electrical stimulus is generally passed across one or more electrodes aimed at a target, such as a human. When the electrical stimulus engages with the target, it generally causes involuntary muscle contractions and sensory responses such as pain and feelings of exhaustion and confusion, which in turn can lead to the temporary incapacitation of the target.

The electrical stimulus is generally in the form of short-duration (ranging anywhere from approximately 10 to 150μ seconds), repetitive pulses (ranging anywhere from approximately 5 to 30 per second), each pulse of approximately 50,000 volts of charge in air. The electrical stimulus is generally applied for a 5 second period and the current in the device generally averages between 2 and 15 ampere. While each pulse is approximately 50,000 volts of charge in air, generally the peak voltage across a human when a human is the target is approximately 1200 volts. The 50,000 volts is often necessary to overcome an impedance gap, such as clothing or air, so that the electrical stimulus can make its way to the skin.

Electro-incapacitation devices generally include at least two electrodes, and in many cases only two. In instances where two electrodes are used, typically the electrodes are spaced approximately 50 mm apart. This is generally true for non-projectile type guns, which often times look like boxes and are sometimes referred to as “drive-stun” devices, as well as for batons and other elongate style devices. The electrodes on these types of devices are usually point or sharp electrodes, meaning they have a very small radius and surface area for distributing the electrical stimulus. The point or sharp electrodes, illustrated in FIG. 1, are often designed in that manner so that they can penetrate through the dead layers of skin in order to engage the live layers. In embodiments where the electrodes are shaped approximately like cylindrical rods, the radii of the electrodes are typically between approximately 1 and 2 mm. When the electrodes are approximately hemispherical surfaces, the radii of curvature of the electrodes are also between approximately 1 and 2 mm. When the electrodes are tapered to a relatively sharp point, the tip radii of curvature of the electrodes are approximately less than 1 mm. As a result, the spacing between the equipotentials, as illustrated in FIG. 1 by the dotted lines surrounding the electrode, that surrounds each electrode is generally very large.

An example of a “drive-stun” device is disclosed in U.S. Pat. No. 4,162,515, entitled “Electrical Shocking Device with Audible and Visible Spark Display” and granted to Gary A. Henderson et al. on Jul. 24, 1979. The Henderson device, an embodiment of which is illustrated in FIGS. 2 and 3, is a battery-powered, hand-held, lightweight electrical shocking device which provides a visible and audible display of sparks continuously upon the operation of a switch. The device is capable of delivering a jolting shock. The device is comprised of a non-conductive housing 12 in a generally annular shape, permitting it to be gripped in one hand. On one surface away from the hand are first and second electrically conductive plates 26, 28 separated from each other by an insulator. Further, an electrical circuit 36 adapted to create an electrical stimulus in the plates comprises a free-running multi-vibrator, a small transformer, a rectifier, a voltage doubler, and an internal spark gap. The circuit 36 can deliver a series of short duration, high voltage, low current electrical shocks, or stimuli, from two penlight batteries 32, 34, through the electrically conductive plates 26, 28, and across electrically conductive projections 110, 114 extending from the face of the plates 26, 28. The electrically conductive projections 110, 114 operate as the point electrodes that deliver the electrical stimuli from the device 10 to a target.

The distance between electrodes is larger for projectile style guns, sometimes called “ballistic stun guns,” because once fired, the projectiles, typically darts, associated with such guns spread apart as they approach a target. The barbed darts in this style of gun are typically fired using compressed gas propellants and can reach targets approximately 5 meters away or further. The wider gap between the electrodes once they reach the target results in a more poignant effect on the target. Even though the wider gap between the electrodes results in having a greater effect on the target, studies have shown that the “drive-stun guns” can be more likely to cause more serious injuries such as ventricular fibrillation or even death because the direct contact between the device and the target means there is no impedance gap, such as the air, to dampen the effect of the electrical exposure from the electrical stimulus created between the point electrodes and the target.

An example of a “ballistic stun gun” is disclosed in U.S. Pat. No. 3,803,463, entitled “Weapon for Immobilization and Capture” and issued to John H. Cover on Apr. 9, 1974. The Cover device discharges a projectile using a launcher with an electrical power supply connected to the projectile by means of a relatively fine, conductive wire. The launcher can vary the magnitude and frequency of the electrical impulses delivered to the projectile, and hence a target, via the launcher.

There are some weapons available that can operate both as a projectile style gun and a non-projectile style gun. In these duel capability weapons, the projectiles may remain as part of the weapon or be reengaged with the remainder of the device to be operated in the “drive-stun” fashion. In alternative embodiments, the weapons may include both a projectile cartridge and a pair of point electrodes to be used at close range.

The use of electrodes is not just limited to “gun style” electro-incapacitation devices. Other devices such as prods, batons, nightsticks, and even flashlights and umbrellas incorporate point electrodes into their design in order to deliver an electrical stimulus to a target using electro-incapacitation devices. In fact, applying a high voltage across point electrodes in order to deliver an electrical stimulus to a target is the most common way in which to incapacitate a target. For example, as disclosed in U.S. Pat. No. 6,791,816, entitled “Personal Defense Device” and issued to Kenneth J. Stethem on Sep. 14, 2004, a high voltage discharge is made across the point electrodes in the end of a baton for application to a target. U.S. Pat. No. 6,439,432, entitled “Personal Safety Device” and issued to John S. Park on Aug. 27, 2002, discloses a flashlight containing point shocking electrodes that are adapted to sting or shock a target upon contact with the electrodes when the electrodes are activated. Further, U.S. Pat. No. 5,282,332, entitled “Stun Gun” and issued to Elizabeth Philips on Feb. 1, 1994, discloses a stun gun disguised as a collapsed umbrella that generates a high voltage across a pair of protruding stainless steel electrodes to be applied to a target when activated.

While the use of electrodes, and associated electrical stimuli, in order to incapacitate a target, like a human, are prevalent in electro-incapacitation devices, electrodes, and associated electrical stimuli, have also found use in the medical field. In particular, a phenomena known as electroporation, which utilizes high voltage pulses to reversibly permeabilize lipid bilayers in the skin to create aqueous pathways that increase skin permeability to ions and macromolecules, is used for drug delivery. The high voltage pulses at the skin, which can range from approximately 30 to 500 volts, but typically range between 50 and 150 volts, are needed in order to overcome the barrier properties of the skin. The barrier properties of the skin can mainly be attributed to the stratum corneum, which is the skin's outer layer of dead tissue comprised of flattened cells filled with cross-linked keratin and an extracellular matrix made of lipids arranged largely in bilayers making up the upper 10 to 20 μm of the epidermis and which has a much higher electrical resistance than other parts of the skin. Electroporation allows the transportation of both charged compounds, and to a lesser extent, neutral solutes. It also allows smaller molecules (for example: fentanyl, calcein, sulforhodamine, cascade blue, lucifer yellow, d-aminolevulinic acid, and methylene blue), and to a lesser extent larger molecules (or example: DNA fragments, heparin, protoporphyrin IX, dextrans, insulin, and peptides), sometimes using anionic lipid enhancers, to penetrate the skin and enter the body of a human. Even enzymes, antibodies, viruses, and other agents or particles for intracellular assays can be introduced into a human using this technique. This technique has also been used in localized gene therapy, gene transfection, body fluid sampling, the facilitation of cell fusion, and in enhanced cancer tumor chemotherapy.

Electrodes, and associated electrical stimuli, are also used to pace, fibrillate, or defibrillate the human heart. While this is a technique that has been evolving since the late eighteenth and early nineteenth century, today studies show that the optimal size of electrodes for this use are large, for example, having a surface area of approximately 90 cm². Of course, the focus of using electrodes and their associated electrical stimuli with the heart has always been to help and save lives, while the use of electrodes and their associated electrical stimuli with electro-incapacitation devices has always been to effectively, but temporarily, incapacitate a life.

Given the many side effects of electro-incapacitation devices, there exists a need for an electro-incapacitation device that reduces localized cellular damage created by the electrical stimuli of such a device. Further, there also exists a need for an electro-incapacitation device that reduces spacing between equipotentials, thereby reducing a magnitude of an electric field, near the electrodes of such a device.

### SUMMARY OF THE INVENTION

Electrodes, methods, and devices are provided for incapacitating or immobilizing a target. In one embodiment, an electro-incapacitation device is provided and includes at least one electrode adapted to deliver an incapacitating electrical impulse to a target. The electrode can have a terminal end adapted to contact the target, and in at least one embodiment, the terminal end can include a blunt contact surface configured to reduce the spacing between equipotentials at the terminal end. Reducing the spacing between equipotentials at the terminal end thereby results in reducing the magnitude of the electric field. The terminal end can be configured in a variety of different manners, including such that it has a surface area of approximately at least 10 mm². Other configurations can include a surface area in the range of about 20 to 50 mm² or at least 100 mm², depending on the desired application of the device. Additionally, the terminal end can be configured such that it includes a curved contact surface. The resulting radius of curvature can be a variety of sizes, depending on the desired application of the device, but some of the radius sizes include a radius of curvature of approximately at least 2.5 mm, in the range of about 2.5 to 4 mm, of approximately at least 10 mm, and of approximately 100 mm. Further, the contact surface of the terminal end can be substantially flat, and in one embodiment, the contact surface is substantially circular. In at least one embodiment, the device can be hand-held.

In a second embodiment, an electro-incapacitation device is provided and includes at least one electrode adapted to deliver an incapacitating electrical impulse to a target. The electrode can have a terminal end adapted to contact the target, and in at least one embodiment, the terminal end can include a blunt contact surface configured to reduce localized cellular damage created by the incapacitating electrical impulse.

In other aspects, a method for manufacturing an electro-incapacitation device is provided and includes configuring at least one electrode to reduce spacing between equipotentials, and thereby to reduce the magnitude of an electric field, near the electrode, connecting the electrode with a circuit adapted to generate an electrical stimulus, connecting a power supply to the circuit, disposing at least a portion of the power supply and the circuit in a housing, and associating the electrode with the housing such that at least a portion of the electrode is adapted to interact with a target. The device manufactured by the afore-mentioned method can be a hand-held device, including a device like a prod, a baton, a nightstick, a non-projectile style gun, and a projectile-style gun. A trigger can be placed in communication with a switch of the circuit and it can be adapted for operation by an outside force. Further, the electrode of the device can be configured in a variety of different ways in order to reduce the spacing between equipotentials near the electrode, including such that it has a surface area of approximately at least 10 mm². Other configurations can include a surface area in the range of about 20 to 50 mm² or at least 100 mm², depending on the desired application of the device. Additionally, the electrode can be configured such that it includes a curved contact surface. The resulting radius of curvature can be a variety of sizes, depending on the desired application of the device, but some of the radius sizes include a radius of curvature of approximately at least 2.5 mm, in the range of about 2.5 to 4 mm, of approximately at least 10 mm, and of approximately 100 mm. Further, the contact surface of the terminal end can be substantially flat, and in one embodiment, the contact surface is substantially circular.

A method for incapacitating a target is also provided for and includes placing at least one electrode configured to reduce spacing between equipotentials, and thereby reduce the magnitude of an electric field, near the electrode in contact with a target and then providing an electrical stimulus to the electrode in order to create an electrical exposure in the target. In one embodiment, prior to placing the electrode in contact with the target, the electrode can be associated with a hand-held device that is configured to provide an electrical stimulus to the electrode, such as a device like a prod, a baton, a nightstick, a non-projectile style gun, and a projectile-style gun. Further, the electrode of the device can be configured in a variety of different ways in order to reduce the spacing between equipotentials near the electrode, including such that it has a surface area of approximately at least 10 mm². Other configurations can include a surface area in the range of about 20 to 50 mm² or at least 100 mm², depending on the desired application of the device. Additionally, the electrode can be configured such that it includes a curved contact surface. The resulting radius of curvature can be a variety of sizes, depending on the desired application of the device, but some of the radius sizes include a radius of curvature of approximately at least 2.5 mm, in the range of about 2.5 to 4 mm, of approximately at least 10 mm, and of approximately 100 mm. Further, the contact surface of the terminal end can be substantially flat, and in one embodiment, the contact surface is substantially circular.

### BRIEF DESCRIPTION OF THE DRAWINGS

The exemplary embodiments disclosed herein will be more fully understood from the following detailed description taken in conjunction with the accompanying drawings, in which:

FIG. 1 is a cross-sectional side view of two pointed electrodes as currently exist in the prior art;

FIG. 2 a cross sectional end view of an electrical shocking device as currently exists in the prior art;

FIG. 3 is a partial sectional view of the bottom portion of the device of FIG. 2 as currently exists in the prior art;

FIG. 4 is a cross-sectional side view of one exemplary embodiment of electrodes of the present invention;

FIG. 5 is a side view of another exemplary embodiment of an electrode of the present invention indicating the electric potential as mathematically described below;

FIG. 6 is a cross-sectional side view of another exemplary embodiment of electrodes of the present invention;

FIG. 7 is a cross-sectional side view of an alternate embodiment of the electrodes of FIG. 6;

FIG. 8 is a side view of an exemplary embodiment of an electro-incapacitation device of the present invention with a block diagram incorporated within;

FIG. 9 is a block diagram illustration of an exemplary embodiment of a circuit that can be adapted for use in FIG. 8;

FIG. 10 is a block diagram illustration of another exemplary embodiment of a circuit that can be adapted for use in FIG. 8; and

FIG. 11 is a block diagram illustration of another exemplary embodiment of a circuit that can be adapted for use in FIG. 8.

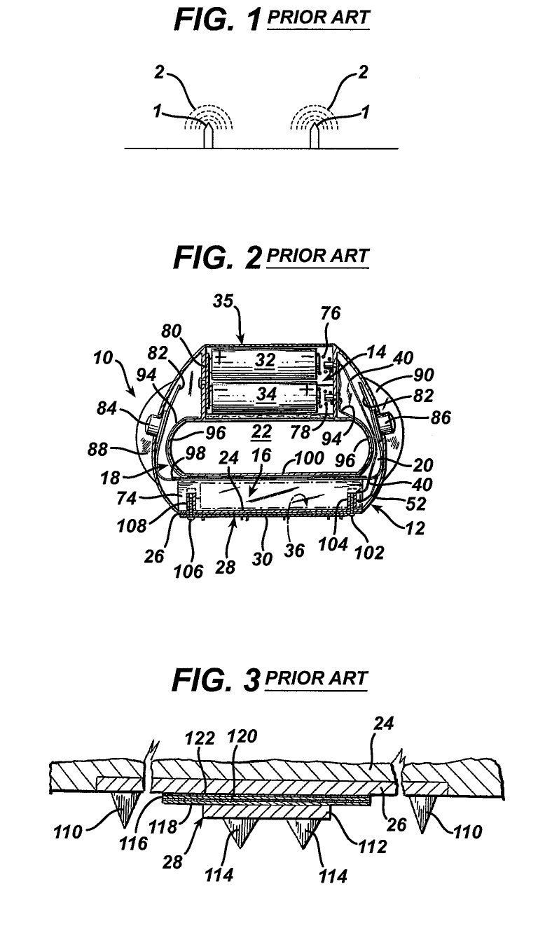

### DETAILED DESCRIPTION OF THE INVENTION

Certain exemplary embodiments will now be described to provide an overall understanding of the principles of the structure, function, manufacture, and use of the electrodes, devices, and methods disclosed herein. One or more examples of these embodiments are illustrated in the accompanying drawings. Those skilled in the art will understand that the electrodes, devices, and methods specifically described herein and illustrated in the accompanying drawings are non-limiting exemplary embodiments and that the scope of the present electrodes, devices, and methods are defined solely by the claims. The features illustrated or described in connection with one exemplary embodiment may be combined with the features of other embodiments. Such modifications and variations are intended to be included within the scope of the present electrodes, devices, and methods.

Electrodes, devices, and methods are provided for incapacitating or immobilizing a target. More particularly, the inventions disclosed herein address ways in which spacing between equipotentials, and thereby the magnitude of an electric field, near an electrode can be reduced and ways in which localized cellular damage created by an electrical exposure from an electrode can be reduced.

Incapacitation or immobilization, which may be used interchangeably but will primarily be referred to as incapacitation throughout, as discussed herein includes any restraint of voluntary motion by a target. For example, incapacitation or immobilization may include causing pain or interfering with normal muscle function. Incapacitation or immobilization need not include all motion or all muscles of the target. Preferably, involuntary muscle functions (e.g., for circulation and respiration) are not disturbed. In variations where the placement of an electrode is regional, loss of function of one or more skeletal muscles accomplishes suitable incapacitation or immobilization. In another implementation, suitable intensity of pain is caused to upset the target's ability to complete a motor task, thereby incapacitating and disabling the target.

A target may be any living organism that an operator of the electrodes, devices, and methods disclosed herein may desire to incapacitate. In many instances, the target may include an animal. For example, the animal may be a human. Alternatively, the animal may be a farm animal. It is anticipated that the electrodes, devices, and methods herein are applicable to any target that a person skilled in the art would recognize would be affected by such electrodes, devices, and methods.

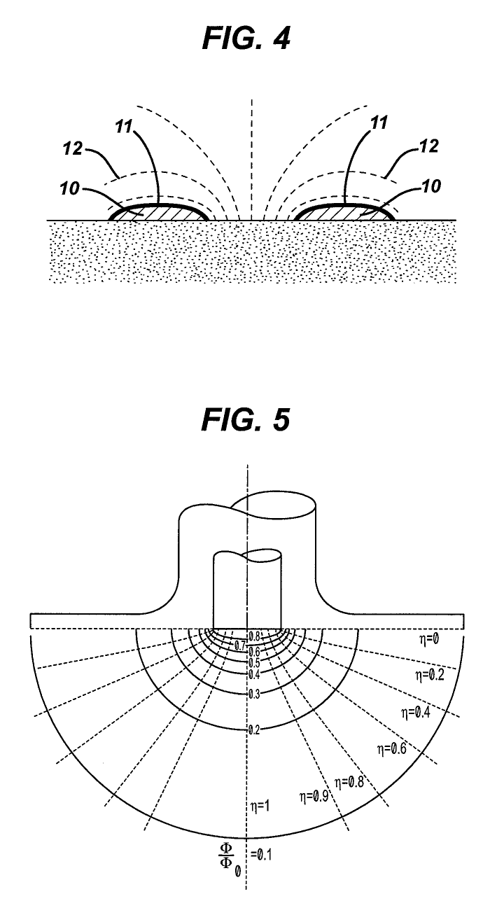

In an exemplary embodiment, illustrated in FIG. 4, spacing between equipotentials 12 near an electrode 10 can be reduced and/or localized cellular damage created by an electrical exposure from the electrode 10 can be reduced by configuring the electrode 10 to be relatively large in comparison to point electrodes typically found on other similar devices. In one embodiment, the electrode 10 is approximately flat. The shape of the approximately flat electrode 10 can be any number of geometric shapes, but in the illustrated embodiment, the electrode is circular. The approximately flat electrode 10 can also be elliptical, rectangular, triangular, trapezoidal, or any other geometric shape. The equipotential near a flat circular electrode, like the illustrated electrode 10, can be reasonably calculated from Laplace's equation, as shown in a paper titled “Resistance for Flow of Current to a Disk” by John Newman, published in the Journal of the Electrochemical Society in 1966 on pages 501 and 502, as follows:

For the purpose of calculating the potential distribution from Laplace's equation, rotational elliptic coordinates ξ and η related to cylindrical coordinates by:
z=aξn
r=a\sqrt{(1+ξ²)}(1−η²)
where a is the radius of the flat circular electrode, z is the normal distance from the electrode, and r is the distance from the axis of symmetry are used (see FIG. 5, where lines of constant Φ are also lines of constant ξ). In this coordinate system Laplace's equation is

$$\frac{\partial }{\partial ξ} [ ( 1 + {ξ}^{2} ) \frac{\partial Φ}{\partial ξ} ] + \frac{\partial }{\partial η} [ ( 1 - {η}^{2} ) \frac{\partial Φ}{\partial η} ] = 0$$

and the boundary conditions are:
Φ=Φ₀ at ξ=0 (on the flat circular electrode)
∂Φ/∂η=0 at η=0 (on the skin)
Φ=0 at ξ=∞ (far from the electrode)
Φ well behaved at η=1 (on the axis of the electrode)
To obtain a solution by the method of separation of variables we set:
Φ=P(η)Q(ξ)
The differential equations for P and Q are:

$$\frac{ⅆ}{ⅆ η} [ ( 1 - {η}^{2} ) \frac{ⅆ P}{ⅆ η} ] + nP = 0 , and$$

$$\frac{ⅆ}{ⅆ ξ} [ ( 1 + {ξ}^{2} ) \frac{ⅆ Q}{ⅆ ξ} ] - nQ = 0$$

where n is the separation constant. The solutions of these equations are Legendre functions. In order to have well behaved solutions, n is restricted to values n=l(l+1) where l=0, 1, 2, . . . In order to satisfy the condition on the skin, l must be even. It turns out that the condition Φ=Φ₀ on the electrode can be satisfied simply with the solution for n=0. Integration thus yields:

$$\frac{Φ}{{Φ}_{0}} = 1 - ( \frac{2}{π} ) {tan}^{- 1} ξ$$

The resulting equipotential lines of the electric field of the flat circular electrode are shown on FIG. 5. Far from the electrode the potential approaches

$$Φ \to \frac{2 {Φ}_{0} a}{π ρ} as ρ \to ∞$$

where ρ is the distance from the center of the electrode in spherical coordinates. This formula can be used to estimate the error for the situation where the reference electrode is not at infinity and the potential field is distorted by some other object.

A person skilled in the art will recognize that the size of the flat electrode 10 is dependent upon how the electrode 10 is going to be used. For example, electrodes that are incorporated into a device such as a stun gun will generally be smaller than electrodes that are incorporated into a device such as a flat end of a baton because a surface area of a target that will be contacted by a flat end of a baton will generally be larger than a surface area of a target that will be contacted by a stun gun. In one embodiment, a surface area of the electrode 10 can be approximately at least 10 mm². In other embodiments, the surface area of the electrode 10 can be in a range of about 20 to 50 mm². Still, when even larger surface areas are desired, the surface areas of the electrode 10 can be approximately at least 100 mm², or even greater as the situation may require.

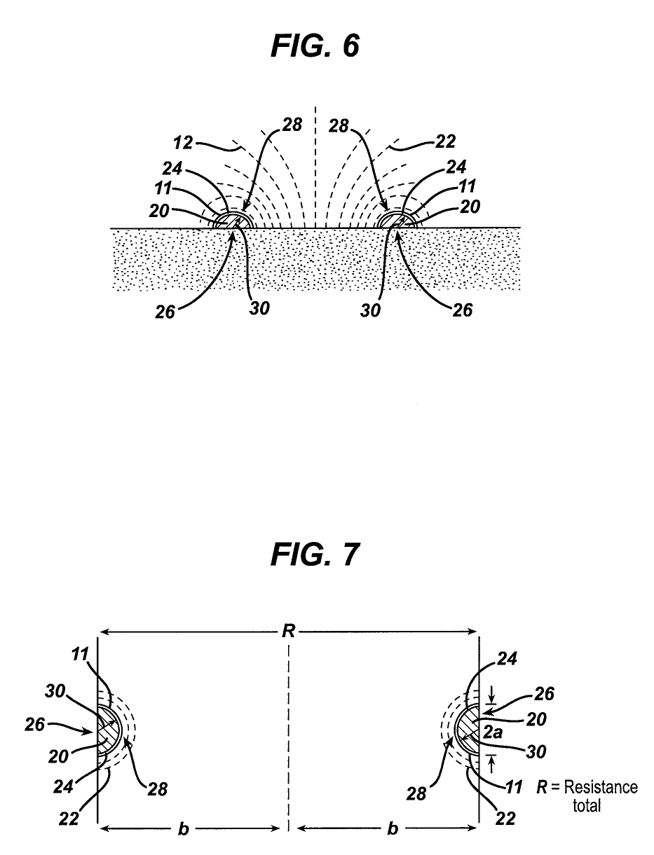

In another exemplary embodiment, illustrated in FIGS. 6 and 7, spacing between equipotentials 22 near an electrode can be reduced and localized cellular damage created by an electrical exposure from an electrode 20 can be reduced by configuring at least one end of an electrode 20 to include a curvature 24. In one embodiment, the electrode 20 is approximately hemi-spherical, although any number of curved shapes can be formed. The electrode 20 can include first and second terminal ends 26, 28, where the first end 26 can be adapted to receive an electrical stimulus and the second end 28 can include the curvature 24. The second end 28 can be adapted to contact a target, and in one embodiment, can include a blunt contact surface. In another embodiment, the first and second ends 26, 28 are smooth, polished, and/or gently curved to prevent sharp and/or rough edges on an outer portion of the electrode. The electric field near an electrode with a curvature, like the illustrated electrode 20, can be reasonably calculated as follows:
The equation to estimate the size of the electric field near the electrode in relation to the radius of the curvature is:

$$E ( r ) = \frac{{aV}_{app}}{2 {r}^{2}}$$

where a represents the size of the electrode radius, Vₐₚₚ represents the voltage applied across the electrodes, and r represents the radial distance from the electrode center. Applying this equation to FIG. 7 as drawn, the maximum size of the electric field is approximately:

$${E ( r )}_{max} = \frac{{V}_{app}}{a}$$

because the size of the electric field is greatest just at the surface of the electrode. Similarly, the minimum size of the electric field is approximately:

$${E ( r )}_{min} = \frac{{aV}_{app}}{{b}^{2}}$$

because the size of the electric field is least at the distance furthest from the electrode, which in this case is b because b represents the radial distance to the center between the two electrodes from the center of each electrode.
For example, if a is 3 mm and b is 100 mm, the maximum size of the electric field is:

$$1.7 ⨯ {10}^{4} \frac{V}{mm}$$

and the minimum size of the electric field is:

$$1.5 ⨯ 10 \frac{V}{mm}$$

Thus, in order to reach what is known to those of skill in the art as supra-electroporation, where E(r) is approximately greater than or equal 5 kV/mm, r, the radial distance from the electrode center, needs to be about 2.2 mm, while to reach what is known to those of skill in the art as conventional-electroporation, where E(r) is approximately greater than or equal to 0.1 kV/mm, r needs to be about 16 mm.

A person skilled in the art will recognize that the size of a radius 30 of the curvature 24 of the electrode 20 is dependent upon how the electrode 20 is going to be used. For example, electrodes that are incorporated into a device such as a stun gun will generally have a smaller radius of curvature than electrodes that are incorporated into a device such as a flat end of a baton because a surface area of a target that will be contacted by a flat end of a baton will generally be larger than a surface area of a target that will be contacted by a stun gun. In one embodiment, the radius 30 of the curvature 24 can be approximately at least 2.5 mm. In other embodiments, the radius 30 of the curvature 24 can be in a range of about 2.5 to 4 mm. Still, when even larger radii of curvature are desired, the radius 30 of the curvature 24 can be approximately at least 10 mm, at least 100 mm, or even greater as the situation may require.

While the configurations of the electrodes 10, 20 have been discussed in reference to the electrode 10 being approximately flat and the electrode 20 including a curvature, a person skilled in the art will recognize that the electrodes 10, 20 can be both approximately flat and include a curvature. Furthermore, other configurations of the electrodes 10, 20 known to those skilled in the art that will either reduce spacing between equipotentials, and thereby reduce the magnitude of the electric field, near an electrode or reduce the localized cellular damage created by the electrical exposure from the electrode can also be incorporated with any of the embodiments discussed herein.

The electrodes 10, 20 can be made of any material known to those skilled in the art to be electrically conductive, but in one embodiment, the electrodes 10, 20 are metal. By way of non-limiting example, other electrically conductive materials that can be used to form the electrodes 10, 20 include carbon, carbon-based electrically conductive materials, semiconductive materials, or electrically conducting polymers.

While the electrodes 10, 20 can be made of an electrically conductive material, one or more electrically resistant materials can optionally be applied to the electrodes 10, 20. Coating the electrodes 10, 20 in an electrically resistant material can make the electrodes 10, 20 less visible. Further, it can provide protection against corrosion. It is preferable that the coating of the electrically resistant material not substantially affect operation of the electrodes 10, 20 to incapacitate a target. To that end, in one embodiment the coating is a thin, resistive material. In the embodiments illustrated in FIGS. 4 and 6 the electrodes 10, 20 a coating 11 is aluminum oxide. In yet another embodiment, the electrodes 10, 20 can be coated in a dielectric coating. A person skilled in the art will recognize there are many electrically resistant materials that can be used to coat the electrodes 10, 20.

In use, an electrode that is approximately flat and an electrode that includes a curvature are effective to both reduce spacing between equipotentials near the electrode and reduce localized cellular damage created by an electrical stimulus.

An approximately flat electrode, such as the electrode 10 of FIG. 4, reduces spacing between equipotentials 12 near the electrode 10 because the flat electrode provides a greater surface area to distribute the electrical stimulus across than conventional point electrodes. As the equipotentials 12 are allowed to disperse across a greater surface area, the concentration within a particular area will be reduced. Further, reducing the electric field can result in a substantial reduction in localized cellular damage.

An electrode with a curvature 24, such as the electrode 20 of FIGS. 6 and 7, reduces spacing between equipotentials 22, and thereby reduces the magnitude of an electric field, near the electrode 20. As a radius 30 of the curvature 24 increases, similar to the approximately flat electrode 10, the equipotentials 22 are more spread out. Further, because the curvature 24 provides for less of an indent or dimple of the skin and a smaller field, localized cellular damage is reduced.

The electrodes 10, 20 as described herein can be operated by placing the electrodes 10, 20 in contact with a target and providing an electrical stimulus across the target. In an exemplary embodiment, two electrodes can be placed in contact with the target and an electrical stimulus can be applied across the target. In other embodiments, more than two electrodes can be used.

Those skilled in the art will recognize that there are a number of different ways in which an electrical stimulus can be applied to an electrode, but in an exemplary embodiment, the electrodes 10, 20 can be associated with an electro-incapacitation device. In one embodiment, the electro-incapacitation device can be a hand-held device that provides the operator the ability to easily use and control the device with a single hand. Examples of such hand-held devices that the electrodes 10, 20 could be associated with include: a prod, a baton, a nightstick, a projectile-style gun, and a non-projectile style gun, although a person skilled in the art will recognize that there are many other devices, hand-held or otherwise, that the electrodes 10, 20 can be associated with or incorporated into. Further, one skilled in the art will recognize that although electrodes 10, 20 have been discussed together in some aspects, electrodes 10, 20 can be used both separately and together.

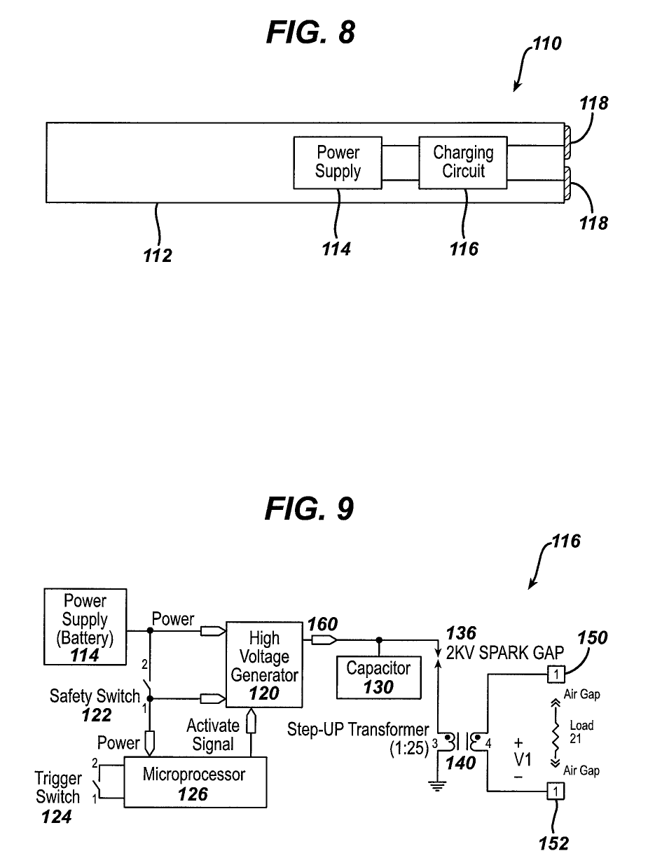

While exemplary embodiments thus far have been discussed with respect to an electrode, in another exemplary embodiment, illustrated in FIG. 8, an electro-incapacitation device 110 can include a housing 112, a power supply 114, a charging circuit 116 connected to the power supply 114 and adapted to generate an electrical stimulus, and at least one electrode 118 in communication with the circuit 116 to receive the electrical stimulus and configured to reduce spacing between equipotentials, and thereby reduce the magnitude of an electric field, near the electrode 118. In an alternative exemplary embodiment, an electro-incapacitation device can include the same components as the previously described electro-incapacitation device, but the electrode 118 can be replaced by an electrode configured to reduce localized cellular damage created by the electro-incapacitation device. In still another embodiment, an electrode of a similar electro-incapacitation device can both reduce spacing between equipotentials near the electrode and reduce localized cellular damage created by the electro-incapacitation device.

The housing 112 of the electro-incapacitation device 110 can be of any shape and size, although preferably it is of a size and shape to have at least a portion of the power supply 114 and the circuit 116 disposed within it. In one embodiment, the housing 112 is of a shape and size such that it can be easily operated by one hand. More likely than not, the size and shape of the housing will depend on the type of electro-incapacitation device that the housing is adapted for. The housing can be adapted for any number of electro-incapacitation devices, including, for example: a prod, a baton, a nightstick, a projectile-style gun, and a non-projectile style gun. Similarly, the type of materials that the housing can be composed of will likely depend on the type of electro-incapacitation device that the housing is adapted for. Preferably, the housing is made of non-conductive materials, such as plastics or other non-conductive materials known to those skilled in the art. Two non-limiting examples of plastic materials that can be used to form the housing are polyethylene and polypropylene. In a preferred embodiment, the material of the housing 12 can have a very high dielectric property, at least greater than that of air, in order to preclude electrical arcing across or through the housing 112. Further, it some embodiments, for example when the electro-incapacitation device is a baton or a nightstick, it is preferable that the housing is formed of a high strength synthetic composite or non-composite material for optimum durability.

The power supply 114 of the electro-incapacitation device 110 can be any power supply known to those skilled in the art for use in an electro-incapacitation device. In one embodiment, the power supply 114 can be batteries. For example, in an embodiment where the electro-incapacitation device is hand-held, the power supply can be 8 AA size (1.5 volt nominal) batteries. Alternatively, 4 or 2 AA size batteries can be used, or any other size and amount of batteries known to those skilled in the art for use in electro-incapacitation devices, which include, by way of non-limiting examples: size C, size D, 9 volt, lithium ion, nickel cadmium, nickel metal hydride, alkaline, and rechargeable batteries. In another embodiment of the power supply, illustrated in FIG. 9, can include a high voltage generator 120 which can increase the amount of voltage created by the power supply 114 on its own. In yet another embodiment, the power supply is wrapped in an insulating sleeve of neoprene or other similar material in order to keep the power supply warm and provide it more efficient operation in colder temperatures.

The circuit 116 of the electro-incapacitation device 110 can be any circuit known to those skilled in the art for use in an electro-incapacitation device. In fact, many circuits are known and disclosed in patents and published applications for electro-incapacitation devices. Some examples are the circuits disclosed in U.S. Pat. Nos. 7,102,870 and 7,145,762, entitled “Systems and Methods for Managing Battery Power in an Electronic Disabling Device” and “Systems and Methods for Immobilizing Using Plural Energy Stores,” respectively, and both issued to Magne Nerheim in 2006 (the first on September 5 and the second on December 5), U.S. Pat. No. 4,872,084, entitled “Enhanced Electrical Shocking Device with Improved Long Life and Increased Power Circuitry” and issued to Brian Dunning et al. on Oct. 3, 1989, and United States Publication No. 2007/0109712, entitled “Systems and Methods for Immobilizing Using Waveform Shaping” and filed for by Magne Nerheim on Dec. 4, 2006, which are hereby incorporated by reference in their entireties.

FIG. 9 illustrates one embodiment of the circuit 116 for the electro-incapacitation device 110. Closing safety switch 122 connects the power supply 114 to a microprocessor 126 and places the electro-incapacitation device 110 in the ready to operate configuration. Subsequent closure of a trigger switch 124 causes the microprocessor 126 to activate the power supply 114 which both generates a pulsed voltage output on the order of 2000 volts and is coupled to charge an energy storage capacitor 130 up to the 2000 volt output voltage of the power supply 114. Spark gap 136 periodically breaks down, causing a high current pulse through transformer 140 which transforms the 2000 volt input into a 50,000 volt output pulse. After the trigger switch 124 is closed, the high voltage generator 120 begins charging the energy storage capacitor 130 up to the 2000 volt peak output voltage of the high voltage generator 120. When the output voltage of the power supply 120 reaches the 2000 voltage spark gap breakdown voltage, a spark is generate across the spark gap 136. Ionization of the spark gap 136 reduces the spark gap impedance from a near infinite impedance level to a near zero impedance and allows the energy storage capacitor 130 to almost fully discharge through step up transformer 140. As the output voltage of the energy storage capacitor 130 rapidly decreases from the original 2000 volt level to a much lower level, the current flow through the spark gap 136 decreases toward zero causing the spark gap 136 to deionize and to resume its open circuit configuration with a near infinite impedance. This “reopening” of the spark gap 136 defines the end of the first 50,000 volt output pulse which is applied to output electrodes 150, 152. Typically, a circuit of this arrangement will produce between 5 to 20 pulses per second.

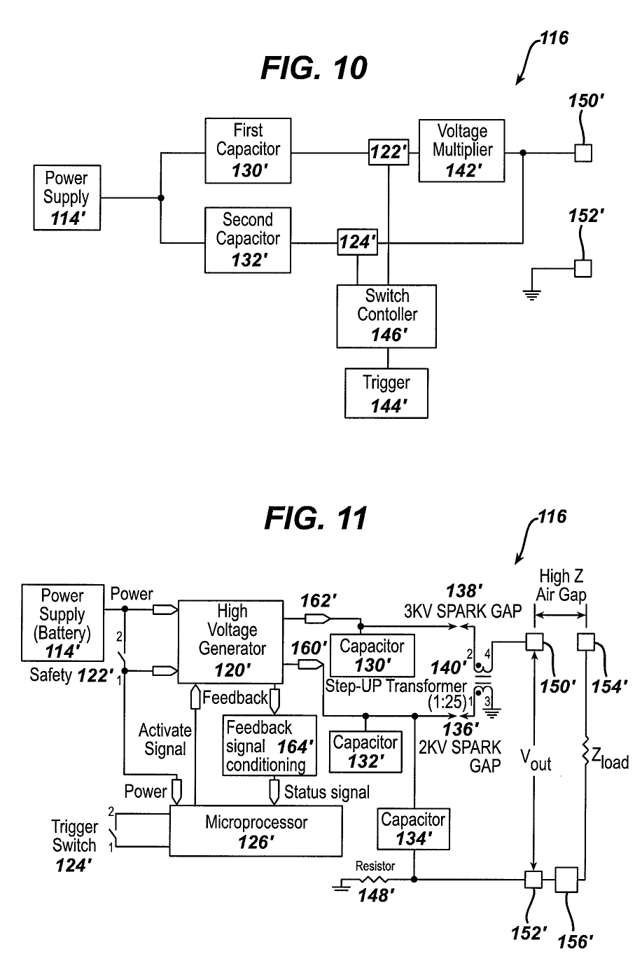

Referring now to FIG. 10, another embodiment of a circuit 116′ for the electro-incapacitation device 110 is provided. This circuit 116′ includes a power supply 114′, first and second energy storage capacitors 130′, 132′, and switches 122′, 124′ which operate as single pole, single throw switches and serve to selectively connect the two energy storage capacitors 130′, 132′ to down stream circuit elements. The first energy storage capacitor 130′ is selectively connected by switch 122′ to a voltage multiplier 142′ which is coupled to first and second electro-incapacitation device electrodes 150′, 152′. The first leads of the first and second energy storage capacitors 130′, 132′ are connected in parallel with the output of the power supply 114′. The second leads of each capacitor 130′, 132′ are connected to ground to thereby establish an electrical connection with the grounded output electrode 152′. A trigger 144′ controls a switch controller 146′ which controls the timing and closure of switches 122′, 124′.

When the power supply 114′ is activated, the energy storage capacitor 130′ charges. Subsequently, when the switch controller 146′ closes switch 122′, the output of the first energy storage capacitor 130′ is coupled to the voltage multiplier 142′ such that the output of the voltage multiplier 142′ rapidly builds from a zero voltage level such that the voltage can go across the 150′ to 154′ (which represents the target contact point) high impedance air gap and thereby form an electrical stimulus having ionized air within the air gap. The air gap impedance then drops from a near infinite level to a near zero level. Once this low impedance ionized path has been established by this short duration application of the voltage, the switch controller 146′ opens switch 122′ and closes switch 124′ to directly connect the second energy storage capacitor 132′ across the electro-incapacitation device output electrodes 150′, 152′. Then, the relatively low voltage derived from the second output capacitor 132′ is directly connected across the electrodes 150′, 152′. Because the ionization of the air gap dropped the air gap impedance to a low level, application of the relatively low voltage of the second capacitor 132′ across the 150′ to 154′ air gap allows the second energy storage capacitor 132′ to continue and maintain the previously initiated discharge across the arced-over air gap for a significant additional time interval. This continuing, lower voltage discharge of the second capacitor 132′ during the additional time interval transfers a substantial amount of target-incapacitating electrical charge through the target.

The continuing discharge of the second capacitor 132′ through the target will exhaust the charge stored in the second capacitor 132′ and will ultimately cause the output voltage from the second capacitor 132′ to drop to a voltage level at which the ionization within the air gap will revert to the non-ionized, high impedance state causing cessation of current flow through the target. During the later stages, the power supply 114′ can be disable to maintain a desired pulse repetition rate.

Referring now to the FIG. 11 schematic diagram, the FIG. 10 circuit has been modified to include a third capacitor 134′ and a load diode 148′ (or resistor) connected as shown. The operation of this enhanced circuit diagram will be explained below.

The high voltage generator 120′ generates an output current 160 which charges capacitors 130′ and 134′ in parallel. While the second terminal of capacitor 132′ is connected to ground, the second terminal of capacitor 134′ is connected to ground through a relatively low resistance load diode 148′. The first voltage output of the high voltage generator 120′ is also connected to a 2000 volt spark gap 136′ and to the primary winding of an output transformer 140′ having a 1 to 25 primary to secondary winding step up ratio.

The second equal voltage output of the high voltage generator 120′ is connected to one terminal capacitor 132′ while the second capacitor terminal is connected to ground. The second power supply output terminal is also connected to a 3000 volt spark gap 138′. The second side of the spark gap 138′ is connected in series with the secondary winding of the transformer 140′ and to electro-incapacitation device electrode 150′.

Closure of safety switch 122′ enables operation of the high voltage generator 120′ and places the electro-incapacitation device 110 in the ready to operate configuration. Closure of the trigger switch 124′ causes the microprocessor 126′ to send a control signal to the high voltage generator 120′ which activates the high voltage generator 120′ and causes it to initiate current flow 160 into capacitors 130′, 134′ and current flow 162 into capacitor 132′. Capacitors 130′, 132′, and 134′ begin charging from a zero voltage up to the 2000 volt output generated by the high voltage generator 120′. Spark gaps 136′, 138′ remain in the open, near infinite impedance configuration because only once the capacitors approach the 2000 volt breakdown voltage will the 130′/132′ capacitor output voltage approach the 2000 volt breakdown rating of the spark gap 136′.

As the voltage on capacitors 130′ and 132′ reaches the 2000 volt breakdown voltage of the spark gap 136′, a spark will be formed across the spark gap 136′ and the spark gap impedance will drop to a near zero level. Capacitor 130′ will begin discharging through the primary winding of transformer 140′ which will rapidly ramp up the 150′ to 152′ secondary winding output voltage to −50,000 volts. The voltage across capacitor 130′ relatively slowly decreases from the original 2000 volt level during this time. Next, the 3000 volt spark gap 138′ spark gap is ionized into a near zero impedance level allowing capacitors 132′ and 134′ to discharge across the electro-incapacitation device electrodes 150′, 152′ through the relatively low impedance load target. Because the voltage across 130′ will have discharged to a near zero level at this point, the capacitor 130′ has effectively and functionally been taken out of the circuit.

In one embodiment of the FIG. 11 circuit, capacitor 130′, the discharge of which provides the relatively high energy level required to ionize the high impedance air gap between 150′ and 154′, can be implemented with a capacitor rating of 0.14 microFarads and 2000 volts. Capacitors 132′ and 134′, meanwhile, in one embodiment, can be selected as 0.02 microFarad capacitors for a 2000 power supply voltage and operate during a certain time interval to generate the relatively low, voltage output to maintain the current flow through the now low impedance electrode to target air gap.

Due to many variables, the duration in which each of these steps can occur can change. For example, a fresh battery may shorten the initial charging time in comparison to circuit operation with a partially discharged battery. Similarly, operation of the electro-incapacitation device in cold weather, which can degrade battery capacity, might also affect the various time intervals.

Because it is highly desirable to operate the electro-incapacitation device 110 with a fixed pulse repetition rate, the circuit 116 can also include a microprocessor-implemented digital pulse control interval. As illustrated in the FIG. 11 block diagram, the microprocessor 126′ can receive a feedback signal from the high voltage generator 120′ via a feedback mechanism, like the illustrated feedback signal conditioning element 164′, which provides a circuit operating status signal to the microprocessor 126′. The microprocessor 126′ is thus able to detect when particular times are reached in order to allow for a fixed pulse repetition rate. For example, since the commencement time of the operating cycle is known, the microprocessor 126′ can maintain the high voltage generator 120′ in a shut down or disabled operating mode when it is not needed until the preset pulse repetition rate defined by the time interval is achieved.

The circuit 116 of the electro-incapacitation device 110 can be used in a variety of different types of devices, including in devices that may be contacted by high impact forces. Accordingly, in a preferred embodiment, the circuit 116, and the components thereof, can be adapted to provide great durability and resistance to damage under high impact forces. In one embodiment, the circuit can include flexible circuitry. Flexible circuitry uses thin, flexible plastic sheet material with conductive material imprinted or otherwise formed thereon, in a similar manner as is used in the formation of conventional printed circuit boards and the like, rather than conventional insulated wires.

While the illustrated embodiments discuss the creation of an electrical stimulus to create electrical exposures within a target by using voltage across a circuit, alternative embodiments can use current waveforms in order to generate an electrical stimulus. Representative suitable waveforms can be similar in waveform morphology (shape) to those waveforms used in other electro-incapacitation devices, but often with smaller waveform amplitudes. Exemplary devices described in U.S. Publication No. 2006/0256498, entitled “Systems and Methods for Immobilization Using Charge Delivery” and filed for by Patrick W. Smith et al. on Feb. 22, 2006 and U.S. patent application Ser. No. 11/208,762, entitled “Modular Personal Defense System” and filed for by Kenneth J. Stethem on Aug. 23, 2005, are hereby incorporated by reference in their entireties. The feature of employing smaller waveforms than in prior electro-incapacitation devices is related to the geometry of the electrode, because the geometries disclosed herein result in smaller equipotentials, and thus smaller electric fields, near the electrodes than in these other devices. This can result in a smaller total voltage drop across the tissue between the electrodes. Thus, a smaller voltage or smaller current can be used to achieve the same exposure near or within one or more excitable cells or tissues within a target.

Now referring to the at least one electrode 118 of the electro-incapacitation device 110, it can be any electrode as discussed earlier, but preferably it can be configured to reduce spacing between equipotentials, and thereby the magnitude of an electric field, near the electrode, configured to reduce localized cellular damage created by the electro-incapacitation device, or it can be configured to accomplish both a reduced spacing between equipotentials near the electrode and reduced cellular damage created by the electro-incapacitation device. The at least one electrode can be removable and/or replaceable. In an exemplary embodiment, the at least one electrode is two electrodes. In other embodiments, the at least one electrode is more than two electrodes.

In use, the electro-incapacitation device 110 can operate in a variety of different ways, depending on the type of device that is being operated. In an exemplary embodiment, however, the electro-incapacitation device 110 can include a trigger 170, which can be in communication with the circuit 116 in order to operate the circuit 116. Engaging the trigger 170 can result in closing a switch in the circuit 116. Closing the circuit 116 can allow the electro-incapacitation device 110 to generate power from the power supply 114, charge various components of the circuit 116 as described above, and thus create an electrical stimulus to create an electrical exposure that engages a target. In another embodiment, contact with a target can close the circuit 116, which in turn enables the electro-incapacitation device 110 to operate substantially as described above. One skilled in the art will recognize that there are a myriad of ways in which the electro-incapacitation device 110 can be operated, and that the methods discussed herein are but a few examples of many that can be used in order to operate the electro-incapacitation device.

In an exemplary method for manufacturing an electro-incapacitation device 110, at least one electrode 10 can be configured to reduce spacing between equipotentials, and thereby the magnitude of an electric field, near the electrode and connected to at a circuit 116 that is adapted to generate an electrical stimulus, and further, the circuit 116 can be connected to a power supply 114. Additionally, at least a portion of the power supply 114 and the circuit 116 can be disposed in a housing 112 and the at least one electrode 10 can be associated with the housing 112 in a manner that allows at least a portion of the electrode 10 to be adapted to interact with a target. In an alternative exemplary embodiment, at least one electrode 20 can be configured to reduce localized cellular damage created by an electrical exposure from the electrode 20 and connected to a circuit 116 that is adapted to generate an electrical stimulus that results in the electrical exposure, and further, the circuit 116 can be connected to a power supply 114. Additionally, at least a portion of the power supply 114 and the circuit 116 can be disposed in a housing 112 and the at least one electrode 20 can be associated with the housing 112 in a manner that allows at least a portion of the electrode 20 to be adapted to interact with a target. In still another embodiment, an electro-incapacitation device 110 can be manufactured in a similar fashion as described above, except an electrode can be configured to both reduce spacing between equipotentials near the electrode and reduce localized cellular damage created by an electrical exposure from the electrode. In this embodiment, the electrode can still be connected to a circuit that is adapted to generate an electrical stimulus.

In one exemplary method for manufacturing, the step of configuring the electrode to reduce spacing between equipotentials near the electrode and/or to reduce the localized cellular damage created by the electrical exposure from the electrode can further including approximately flattening the electrode. The resulting shape can be any number of geometric shapes, but in an exemplary embodiment, the electrode is circular. The resulting shape can also be elliptical, rectangular, triangular, trapezoidal, or any other geometric shape.

In addition to resulting in a geometric shape, the step of approximately flattening the electrode can result in a surface area of the electrode that is larger than before the electrode was approximately flattened. In one embodiment, the resulting surface area of the electrode can be approximately at least 10 mm². In other embodiments, the resulting surface area of the electrode can be in a range of about 20 to 50 mm². Still, in instances where an even larger surface area is desired, the electrode can be flattened such that the surface area of the electrode is approximately at least 100 mm², or even greater as the situation may require.

In another exemplary method for manufacturing, the step of configuring the electrode to reduce spacing between equipotentials near the electrode and/or to reduce the localized cellular damage created by the electrical exposure from the electrode can further including curving at least one end of the electrode. In one embodiment, the resulting shape is approximately hemi-spherical, although any number of curved shapes can result from the curving step. In fact, any shape with an aspheric surface can also be curved in the manner described herein in order to create the electrode as described. In another embodiment, the method can include a step of smoothing, polishing, and/or gently curving an outer portion of the electrode to prevent sharp and/or rough edges on the outer portion.

In addition to resulting in a curved shape, the step of curving the at least one end of the electrode can result in a radius of curvature of the electrode that is larger than conventional pointed electrodes. In one embodiment, the resulting radius of the curvature of the electrode can be approximately at least 2.5 mm. In other embodiments, the resulting radius of the curvature can be in a range of about 2.5 to 4 mm. Still, when even larger radii of curvature are desired, the resulting radius of the curvature can be approximately at least 10 mm, at least 100 mm, or even greater as the situation may require. Furthermore, because the resulting shape can be any spherical or aspheric shape with a curved portion, reference to a radius of curvature is not intended to limit the type of shapes that can be formed. A person skilled in the art will recognize that an equivalent to a radius of the curvature can easily be determined for any spherical or aspheric shape formed as described herein.

While steps of flattening the electrode and curving the electrode have been discussed in separate embodiments, a person skilled in the art will recognize that both of these steps can be performed on the same electrode. Furthermore, other steps known to those skilled in the art that will either reduce spacing between equipotentials near an electrode or reduce the localized cellular damage created by the electrical exposure from the electrode can also be incorporated into the methods discussed herein.

The steps involving the connection of the circuit can be performed substantially as described above with respect to the description of the various circuit components. More particularly, the step of connecting the electrode to the circuit can be performed in any number of ways known by those skilled in the art, but in an exemplary embodiment, the electrode is wired to the circuit such that it receives a multiplied voltage. In embodiments where the resulting electrical stimulus can be discharged through air, the multiplied voltage can be approximately 50,000 volts. In embodiments where the resulting electrical stimulus will not travel through air, or alternatively can contact a target directly, the multiplied voltage can be less than 50,000 volts. Further, the step of connecting the power supply to the circuit can also be performed in any number of ways known by those skilled in the art, but in an exemplary embodiment, the power supply is a battery which is introduced to the circuit by connecting the appropriate terminals of the battery to the circuit. The circuit can also include any number of other components known to those skilled in the art, including the various components discussed above. In particular, the method for manufacturing described herein can further include making at least one of the following connections: connecting at least one capacitor with the power supply, connecting at least one switch to the circuit such that it is adapted to selectively open and close the circuit to generate the electrical stimulus, connecting a trigger to the at least one switch such that the trigger can be adapted to operate the switch from outside of the circuit, connecting at least one voltage multiplier to the at least one capacitor and/or the electrode, connecting at least one spark gap to the at least one capacitor, and connecting a feedback mechanism to the at least one capacitor such that it is adapted to selectively permit the electrical stimulus to be received by the at least one electrode.

The two steps that involve associating the previously discussed components, i.e. the electrode, the circuit, and the power supply, with the housing, can be carried out in a variety of different ways, at least partially dependent on the desired size and shape of the housing. The size and shape of the housing can be determined based on the type of device desired. In an exemplary embodiment, the method is applied to a hand-held device. One skilled in the art will recognize that any number of hand-held devices can be formed using the method as described, including at least: a prod, a baton, a nightstick, a non-projectile style gun, and a projectile style gun. Because it is often desired to protect the power supply and the circuit from the outside environment, in one embodiment substantially all of the power supply and the circuit can be disposed in the housing. In yet another embodiment it can be desirable to allow selective operation of the electro-incapacitation device from outside of the housing, and as a result, a trigger can be placed in communication with the circuit such that the trigger can be operated by an outside force. In one embodiment, the trigger can be in communication with the switch of the circuit. In another embodiment, the trigger is coupled to the housing.

As was indicated above, the step of associating the electrode with the housing can be carried out in a variety of different ways, at least partially dependent on the desired size and shape of the housing. In an exemplary embodiment, the electrode is associated with the housing such that it is adapted to interact with a target. In one embodiment, the electrode is disposed a distance away from the trigger. In another embodiment, the electrode is disposed on an opposite end of the housing when compared to the trigger. In an exemplary embodiment, two electrodes are associated with the housing. In still other embodiments, more than two electrodes are associated with the housing. Furthermore, this step can also be dependent on the type of electro-incapacitation device being manufactured. In an embodiment where the device is a baton, the electrode(s) can be associated with a distal end of the baton. Alternatively, in an embodiment where the device is a baton, the electrode(s) can be disposed on a face of the baton. One skilled in the art will recognize that there are many different locations in which the electrode(s) can be located with respect to the housing.

It will be apparent to those skilled in the art that the disclosed electrodes, methods, and devices for incapacitating or immobilizing through electrical exposures may be modified in numerous ways and may assume many embodiments other than the exemplary forms specifically set out and described above. Accordingly, it is intended by the appended claims to cover all such modifications of the inventions which fall within the true spirit and scope of the inventions. Furthermore, all publications and references cited herein are expressly incorporated herein by reference in their entirety.

What is claimed is:

1. An electro-incapacitation device comprising:
at least one electrode adapted to deliver an incapacitating electrical impulse to a target, the electrode having a terminal end adapted to contact the target;
wherein the terminal end further comprises a blunt contact surface configured to reduce spacing between equipotentials at the terminal end.

2. The device of claim 1, wherein the device is a hand-held device and the device further comprises a body that houses the at least one electrode.

3. The device of claim 1, wherein the device is a projectile device and the device further comprises a projectile that houses the at least one electrode.

4. The device of claim 1, wherein the terminal end has a contact surface area of approximately at least 10 mm².

5. The device of claim 4, wherein the contact surface area is in the range of about 20 to 50 mm².

6. The device of claim 5, wherein the contact surface area of the electrode is approximately at least 100 mm².

7. The device of claim 1, wherein the terminal end further comprises a curved contact surface.

8. The device of claim 7, wherein the curved contact surface has a radius of curvature of approximately at least 2.5 mm.

9. The device of claim 8, wherein the radius of curvature is in the range of about 2.5 to 4 mm.

10. The device of claim 8, wherein the radius of curvature is approximately at least 10 mm.

11. The device of claim 8, wherein the radius of curvature is approximately at least 100 mm.

12. The device of claim 1, wherein the contact surface is substantially flat.

13. The device of claim 1, wherein the contact surface is substantially circular.

14. The device of claim 1, wherein the at least one electrode is two electrodes.

15. The device of claim 1, wherein the at least one electrode is removable and replaceable.

16. The device of claim 1, wherein the electrode further comprises an electrically conductive material is selected from the group consisting of: metallic, carbon, semiconductor, and polymeric materials.

17. The device of claim 1, wherein the electrode further comprises an electrically resistant coating.

18. The device of claim 17, wherein the electrically resistant coating is aluminum oxide.

19. The device of claim 1, wherein the device further comprises at least one capacitor adapted to charge the electrode with electric energy.

20. An electro-incapacitation device comprising:
at least one electrode adapted to deliver an incapacitating electrical impulse to a target, the electrode having a terminal end adapted to contact the target;
wherein the terminal end further comprises a blunt contact surface configured to reduce localized cellular damage created by the incapacitating electrical impulse.

21. A method for manufacturing an electro-incapacitation device, comprising the steps of:
configuring at least one electrode to reduce spacing between equipotentials near the electrode;
connecting the at least one electrode with a circuit adapted to generate an electrical stimulus;
connecting a power supply to the circuit;
disposing at least a portion of the power supply and the circuit in a housing; and
associating the at least one electrode with the housing such that at least a portion of the at least one electrode is adapted to interact with a target.

22. The method of claim 21, wherein the electro-incapacitation device is a hand-held device.

23. The method of claim 22, wherein the hand-held device is selected from the group consisting of: a prod, a baton, a nightstick, a non-projectile style gun, and a projectile style gun.

24. The method of claim 21, further comprising the step of placing a trigger in communication with a switch adapted to selectively open and close the circuit to generate an electrical stimulus and adapting the trigger for operation by an outside force.

25. The method of claim 21, wherein the step of configuring the at least one electrode to reduce the spacing between the equipotentials near the electrode further comprises the step of curving at least one end of the at least one electrode.

26. The method of claim 25, wherein the step of curving the at least one end of the at least one electrode further comprises the step of curving the at least one end to create a curvature radius of approximately at least 2.5 mm.

27. The method of claim 26, wherein the step of curving the at least one end to create the curvature radius of approximately at least 2.5 mm further comprises the step of curving the at least one end to create a curvature radius in the range of about 2.5 to 4 mm.

28. The method of claim 26, wherein the step of curving the at least one end to create the curvature radius of approximately at least 2.5 mm further comprises the step of curving the at least one end to create a curvature radius of approximately at least 10 mm.

29. The method of claim 28, wherein the step of curving the at least one end to create the curvature radius of approximately at least 10 mm further comprises the step of curving the at least one end to create a curvature radius of approximately at least 100 mm.

30. The method of claim 21, wherein the step of configuring the at least one electrode to reduce the spacing between the equipotentials near the electrode further comprises the step of approximately flattening the at least one electrode.

31. The method of claim 30, wherein the step of approximately flattening the at least one electrode further comprises the step of flattening the at least one electrode into an approximately circular shape.

32. The method of claim 30, wherein the step of approximately flattening the at least one electrode further comprises the step of flattening the at least one electrode to create a surface area of approximately at least 10 mm².

33. The method of claim 32, wherein the step of flattening the at least one electrode to create the surface area of approximately at least 10 mm² further comprises the step of flattening the at least one electrode to create a surface area in the range of about 20 to 50 mm².

34. The method of claim 32, wherein the step of flattening the at least one electrode to create the surface area of approximately at least 10 mm² further comprises the step of flattening the at least one electrode to create a surface area of approximately at least 100 mm².

35. A method for incapacitating a target, comprising the steps of:
placing at least one electrode configured to reduce spacing between equipotentials near the electrode in contact with a target; and
providing an electrical stimulus to the at least one electrode in order to create an electrical exposure in the target.

36. The method of claim 35, wherein prior to placing the at least one electrode in contact with the target, the method further comprises the step of associating the at least one electrode with a hand-held device configured to provide the electrical stimulus to the at least one electrode.

37. The method of claim 36, wherein the hand-held device is selected from the group consisting of: a prod, a baton, a nightstick, a non-projectile style gun, and a projectile style gun.

38. The method of claim 35, wherein the at least one electrode configured to reduce the spacing between the equipotentials near the electrode is two electrodes.

39. The method of claim 35, wherein prior to placing the at least one electrode in contact with the target, the method further comprises the step of curving at least one end of the at least one electrode to reduce the spacing between the equipotentials near the electrode.

40. The method of claim 39, wherein the step of curving the at least one end of the at least one electrode further comprises the step of curving the at least one end to create a curvature radius of approximately at least 2.5 mm.

41. The method of claim 40, wherein the step of curving the at least one end to create the curvature radius of approximately at least 2.5 mm further comprises the step of curving the at least one end to create a curvature radius of about 2.5 to 4 mm.

42. The method of claim 40, wherein the step of curving the at least one end to create the curvature radius of approximately at least 2.5 mm further comprises the step of curving the at least one end to create a curvature radius of approximately at least 10 mm.

43. The method of claim 42, wherein the step of curving the at least one end to create the curvature radius of approximately at least 10 mm further comprises the step of curving the at least one end to create a curvature radius of approximately at least 100 mm.

44. The method of claim 35, wherein prior to placing the at least one electrode in contact with the target, the method further comprises the step of approximately flattening the at least one electrode to reduce the spacing between the equipotentials near the electrode.

45. The method of claim 44, wherein the step of approximately flattening the at least one electrode further comprises the step of flattening the at least one electrode into an approximately circular shape.

46. The method of claim 44, wherein the step of approximately flattening the at least one electrode further comprises the step of flattening the at least one electrode to create a surface area of approximately at least 10 mm².

47. The method of claim 46, wherein the step of flattening the at least one electrode to create the surface area of approximately at least 10 mm² further comprises the step of flattening the at least one electrode to create a surface area in the range of about 20 to 50 mm².

48. The method of claim 46, wherein the step of flattening the at least one electrode to create the surface area of approximately at least 10 mm² further comprises the step of flattening the at least one electrode to create a surface area of approximately at least 100 mm².

49. The method of claim 35, wherein the target is an animal.

50. The method of claim 49, wherein the animal is a human.

51. The method of claim 49, wherein the animal is a farm animal.
